(19) United States
(12) Patent Application Publication
(10) Pub. No.: US 2005/0000466 A1
(43) Pub. Date: Jan. 6, 2005

(54) Pet shampoo and dispensing apparatus

(76) Inventor: Gary Falkenberg, Clackamas, OR (US)

Correspondence Address: GLENN C. BROWN, PC, 777 NW WALL STREET, SUITE 308, BEND, OR, 97701, US

(21) Appl. No.: 10/871,723

(22) Filed: Jun. 17, 2004

Related U.S. Application Data
(60) Provisional application No. 60/479,564, filed on Jun. 17, 2003.

(51) Int. Cl. A01K 1/10

(52) U.S. Cl. 119/600

(57) ABSTRACT

The invention comprises an apparatus for mixing and dispensing shampoo solutions for use with pets and other animals. The apparatus includes a primary reservoir, a pump in communication with the reservoir, a nozzle in communication with the pump, and related controls. Water and a predetermined amount of shampoo concentrate are put into the reservoir and mixed as explained in further detail in; the enclosed materials. Once mixed, the controls are reset to enable the solution to be dispensed as an aerated foam from a nozzle.

### CROSS REFERENCE TO RELATED APPLICATIONS

This application is a continuation-in-part of U.S. provisional patent application No. 60/479,564, filed on Jun. 17, 2003. The priority of the prior application is expressly claimed and its disclosure is hereby incorporated by reference in its entirety.

### BACKGROUND OF THE INVENTION

1. Field of the Invention

This invention relates to a device for mixing and applying shampoo for application to pets.

2. Description of the Related Art

A prior art method of bathing an animal is to apply shampoo from a shampoo bottle. The shampoo can be poured into the bather's hand or directly onto the animal. There are some areas on the animal where it is difficult to apply the shampoo using this method. Another problem with this method is that it is difficult to sufficiently dilute the shampoo.

Another prior art method is to place a sump pump in a bath. When the animal is rinsed, the dirty water flows back into the bath. Therefore, a problem with this method is that the dirty water is re-circulated by the sump pump and the animal does not get sufficiently clean.

Another prior art method is to use a Venturi valve attached to the water line, which will draw shampoo into the line. A problem with this method is that a flow rate of about 6 gallons/minute is needed in order to provide enough of a vacuum to draw the shampoo into the line. Such a flow rate is much higher than what is needed to clean the animal, and a lot of water is wasted.

### BRIEF SUMMARY OF THE INVENTION

An animal bathing apparatus is provided that solves the problems of the prior art animal bathing methods.

One object of the animal bathing apparatus is to provide sufficient shampoo dilution.

Another object of the animal bathing apparatus is to provide an efficient flow rate that is high enough to clean the animal, but low enough to conserve water.

A further object of the animal bathing apparatus is to use a fresh shampoo/water mixture, thus eliminating the re-circulation of dirty water.

A further object of the animal bathing apparatus is that the apparatus is portable and easy to use. A user can simply plug in the apparatus, and it is ready to use.

In general the invention comprises an apparatus that is used for mixing and dispensing shampoo solutions for use with pets and other animals. The apparatus includes a primary reservoir, a pump in communication with the reservoir, a nozzle in communication with the pump, and related controls. Water and a predetermined amount of shampoo concentrate are put into the reservoir and mixed. Once mixed, the controls are reset to enable the solution to be dispensed as an aerated foam from a nozzle. The nozzle includes a trigger that is activated to dispense the aerated shampoo foam. Once the shampoo has been applied, the animal is rinsed with clear water. The apparatus can also be configured to dispense a second liquid from a separate reservoir if needed, and as described in more detail below.

### BRIEF DESCRIPTION OF THE DRAWINGS

The nature, principle and utility of the present invention will be clearly understood from the following detailed description when read in conjunction with the accompanying drawings, wherein:

FIG. 1 is a perspective view of the animal bathing apparatus.

FIG. 2 is a close-up view of the control panel.

FIG. 3 shows the spray gun in the “off” position.

FIG. 4 shows the spray gun in the “on” position.

FIG. 5 is a perspective view of an alternate embodiment of the animal bathing apparatus.

The drawings are for illustrative purposes only and are not drawn to scale. In the drawings, the same numbers are used for the same part or portion throughout the drawings.

### DETAILED DESCRIPTION OF THE INVENTION

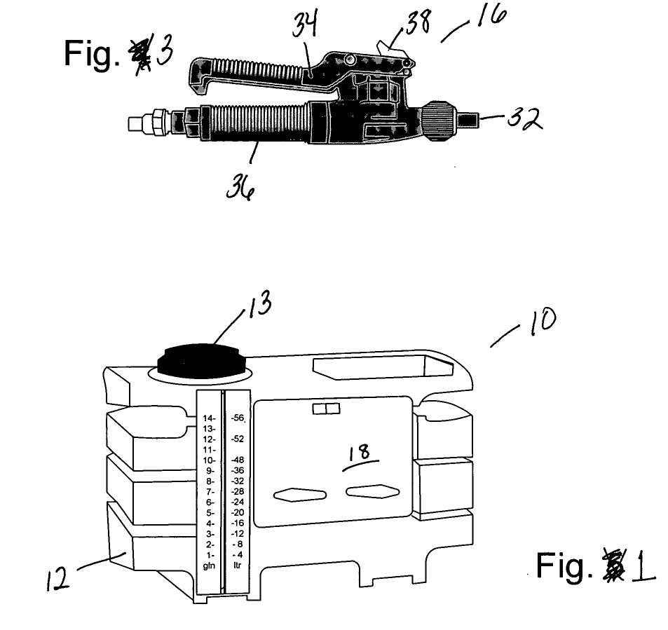

Referring to FIG. 1, the pet washing apparatus is shown generally at 10. The apparatus includes a primary reservoir 12, a lid 13, a tube 14, a spray gun 16 and a control panel 18. The apparatus 10 also includes a pump (not shown). The reservoir can have any desirable dimensions. Preferably, the height of the reservoir is 18 inches, the width is 24 inches and the depth is 14 inches.

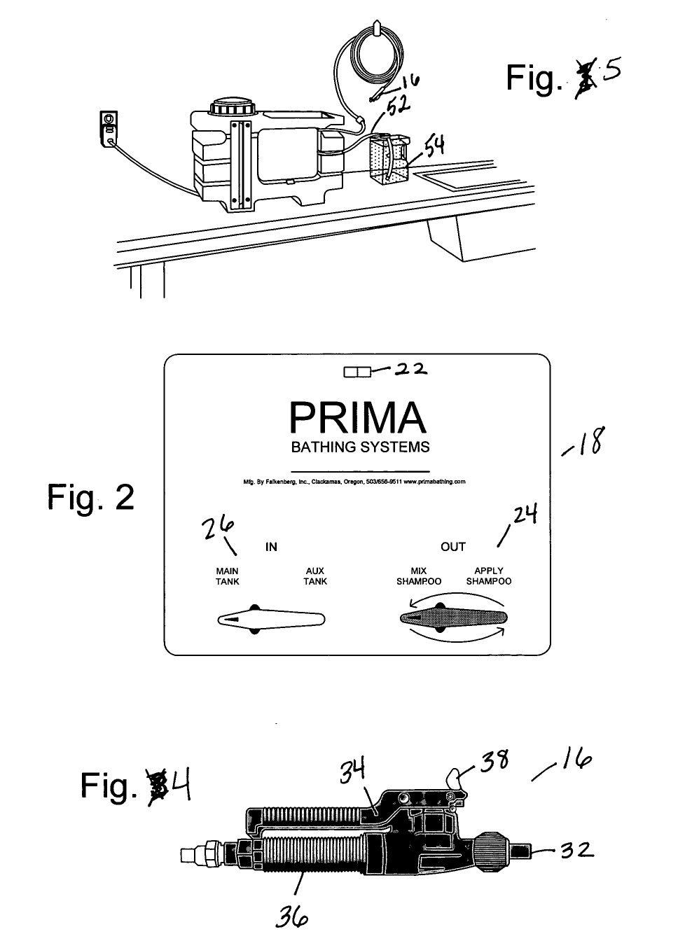

A detailed view of the control panel 18 is shown in FIG. 2. The control panel 18 comprises an on/off switch 22, an “OUT” valve 24 and an “IN” valve 26. The “OUT” valve can be switched between “Mix Shampoo” and “Apply Shampoo”. The “IN” valve can be switched between “Main Tank” and “Aux Tank”.

A detailed view of the spray gun 16 is shown in FIGS. 3 and 4. The spray gun has a nozzle opening 32, a main body 36 and a trigger 34. FIG. 3 shows the spray gun 16 in the off position. To turn the spray gun on, the trigger 34 is squeezed until it is approximately parallel to the main body 36, as shown in FIG. 4. The spray gun also comprises a flip lock 38. In the on position, the flip lock 38 can be pushed forward to lock the spray gun 16 into the on position, as shown in FIG. 4.

To operate the bathing apparatus, the reservoir 12 is filled with shampoo and water. The dilution ratio of water to shampoo can be customized by the operator. Preferably, the dilution ratio of water to shampoo is between 15:1 and 80:1, thus providing greater dilution than the prior art. In order to thoroughly mix the shampoo and water, the pump in the main tank is activated by switching the “OUT” valve 24 on the control panel 18 to “Mix Shampoo”, the “IN” valve 26 to “Main Tank” and the on/off switch 22 to “on”. In the “Mix Shampoo” setting, the pump draws the liquid from the main tank into a tube. The liquid is then expelled from the tube at a flow rate that is high enough to cause the tube whip around, thus acting as a mixing arm.

After the desired mixing time, the “OUT” valve is switched to “Apply Shampoo”. In the “Apply Shampoo” setting, the pump draws the water/shampoo mixture into the tube 14. When the spray gun 16 is in the on position, an aerated water/shampoo foam is dispensed from the nozzle opening. The pressure of the foam will push the foam through the coat of the animal to the skin surface, thus lifting away dead skin cells, dirt, oils and loose hair, without a lot of manual lathering. The animal's coat is then rinsed with clear water. The higher water/shampoo dilution ratio allows for cleaner rinsing and less shampoo residue left behind on the animal's coat.

The animal bathing apparatus is also capable of pumping liquid from an auxiliary tank to the spray nozzle, as shown in FIG. 5. In this auxiliary tank application, the “IN” valve is turned to “Aux Tank” and the tube 52 is placed in the auxiliary tank 54. When the system is turned on, liquid is pumped from the auxiliary tank 54 to the spray nozzle 16. The auxiliary tank application is advantageous for applying a different shampoo solution or a medicated treatment.

While the apparatus is described by reference to the preferred embodiment described below, those of skill in the art will recognize that numerous variations are possible without departing from the scope of the invention.

1. An animal bathing apparatus comprising:
a main reservoir;
a pump;
a tube connected to the pump; and
a spray gun attached to the distal end of the tube,
wherein the apparatus is adapted to mix a solution in the main reservoir and to apply the solution to an animal through the spray gun.

2. The animal bathing apparatus of claim 1, further comprising a control panel for controlling the pump.

3. The animal bathing apparatus of claim 1, wherein the apparatus is adapted to apply a solution from an auxiliary tank.

4. The animal bathing apparatus of claim 3, wherein the auxiliary tank is connected to the pump through a second tube.

5. The animal bathing apparatus of claim 1, wherein the solution comprises water and shampoo.
